(19) United States
(12) Patent Application Publication
(10) Pub. No.: US 2010/0316054 A1
(43) Pub. Date: Dec. 16, 2010

(54) METHOD, SYSTEM AND APPARATUS FOR SENDING MAPPING INFORMATION

(75) Inventors: Xiaohu XU, Shenzhen (CN); Guoping LI, Shenzhen (CN); Enhui LIU, Shenzhen (CN); Sheng JIANG, Shenzhen (CN)

Correspondence Address: STAAS & HALSEY LLP, SUITE 700, 1201 NEW YORK AVENUE, N.W., WASHINGTON, DC, 20005, US

(73) Assignee: HUAWEI TECHNOLOGIES CO., LTD., Shenzhen (CN)

(21) Appl. No.: 12/861,158

(22) Filed: Aug. 23, 2010

Related U.S. Application Data
(63) Continuation of application No. PCT/CN2009/070723, filed on Mar. 10, 2009.

(30) Foreign Application Priority Data
Mar. 14, 2008 (CN) 200810084729.6

(51) Int. Cl. H04L 12/56

(52) U.S. Cl. 370/392

(57) ABSTRACT

A method, system, and apparatus for sending mapping information are disclosed. The method includes the following steps: An endpoint searches a mapping server to obtain Egress Tunnel Router (ETR) information used for forwarding a data packet sent by the endpoint in a transit network; and the endpoint adds the ETR information to the data packet and sends the data packet to an Ingress Tunnel Router (ITR). With the present invention, the ITR does not need to search for Routing Locator (RLOC) information or Autonomous System Number (AS No.) information, the pressure of searching for mapping information on the ITR is relieved, the problems such as forwarding performance deterioration and packet loss caused by ITR overload are avoided, and the risks of Distributed Denial of Service (DDOS) attacks are reduced.

This application is a continuation of International Application No. PCT/CN2009/070723, filed on Mar. 10, 2009, which claims priority to Chinese Patent Application No. 200810084729.6, filed on Mar. 14, 2008, both of which are hereby incorporated by reference in their entireties.

### FIELD OF THE INVENTION

The present invention relates to communications technologies, and in particular, to a method, system, and apparatus for sending mapping information.

### BACKGROUND OF THE INVENTION

In Internet Protocol (IP) communications technologies, the IP address plays a double role. From the perspective of network routing, the IP address is capable of addressing and routing. The IP address identifies the location of an IP device/node in the network, and the network routing protocol sends IP packets to the specified destination according to the IP address. From the perspective of Endpoint Identifier (EID), the IP address represents the identity of a communications node. The endpoint expects that its ID is not lost when it uses different communications nodes and can be identified by the network as the same endpoint consistently. Due to the requirement for a continuous EID, the aggregatability of the IP address is damaged, and the non-aggregatable globally reachable routing entries are increasing. With the development of the network and services, mobile multi-homing endpoints are increasing. The underlying cause of route extensibility, namely, the double role of an IP address, becomes a focus of the problem.

The requirement for route extensibility gives rise to new Internet architectures which separate the ID from the locator. The main conception of such architectures is: The Internet is divided into two parts: a transit network located at the center of the network, and an edge network that is connected to the transit network through a Border Router (BR). The BR knows the routing information in the edge network and the transit network connected to the BR, but does not penetrate the routing information in the two networks reciprocally, as shown in FIG. 1.

In the Locator/ID Separation Protocol (LISP), IP addresses are sorted into two types: Endpoint Identifier (EID) and Routing Locator (RLOC). The route prefix information inside the edge network, namely, EID prefix information, is not spread to the transit network. However, the BR of the edge network is responsible for registering the EID prefix information in the edge network and the BR information with a mapping server.

As shown in FIG. 2, endpoint A in the edge network sends a packet to endpoint B in another edge network. First, the packet arrives at the BR (also known as an Ingress Tunnel Router (ITR)) of endpoint A. The ITR searches a mapping server for mapping information about the longest prefix that matches the destination IP address, and obtains the BR that registers the mapping information, also known as Egress Tunnel Router (ETR) information, namely, RLOC_B. Afterward, the ITR encapsulates the packet through a tunnel between the ITR and the ETR, and forwards the packet to the ETR. The ETR knows the routing information inside the edge network connected to the ETR. After receiving the packet, the ETR decapsulates the packet and discards the tunnel information, and forwards the packet inside the edge network according to the routing table.

The Home Link Prefix (HLP) protocol is another protocol for separating the ID from the locator. The HLP protocol transmits the BR-encapsulated packet in the transit network through a tunnel. The difference is that the HLP uses an Autonomous System (AS) Number (No.) as the locator of the transit network. After the packet arrives at the destination AS, the destination AS decapsulates the packet, and forwards it according to the EID.

The New Scheme for Internet Routing and Addressing (ENCAPS) is another scheme for separating the ID from the locator. The ENCAPS protocol transmits the BR-encapsulated packet in the transit network through a tunnel, and also uses the AS No. as a locator of the transit network. After the packet arrives at the destination AS, the destination AS strips away the encapsulated outer header, and forwards the packet according to the EID.

In the process of implementing the present invention, the inventor finds that the LISP, HLP, and ECAMPS in the prior art involve the same problem: When the ITR receives a packet from endpoint A to endpoint B, the ITR needs to search the ID/locator mapping server for the BR information corresponding to the destination endpoint B. Therefore, the pressure of searching for the mapping information on the ITR is enormous, and even affects the forwarding performance of the ITR.

### SUMMARY OF THE INVENTION

Embodiments of the present invention provide a method, system, and apparatus for sending mapping information to relieve pressure of searching for the mapping information on the ITR at the time of searching for the ETR information corresponding to the destination endpoint on the ITR.

A method for sending mapping information in an embodiment of the present invention includes:

by an endpoint, searching a mapping server to obtain ETR information used for forwarding a data packet sent by the endpoint in a transit network; and

adding the ETR information to the data packet and sending the data packet to an ITR.

A system for sending mapping information in an embodiment of the present invention includes:

an endpoint, configured to: search a mapping server to obtain ETR information used for forwarding a data packet sent by the endpoint in a transit network, add the ETR information to the data packet, and send the data packet; and

an ITR, configured to: receive the data packet that carries the ETR information from the endpoint, resolve the data packet, retrieve the ETR information from the data packet, and encapsulate the data packet according to the ETR information.

An endpoint provided in an embodiment of the present invention includes:

a searching module, configured to search a mapping server to obtain ETR information used for forwarding a data packet sent by the endpoint in a transit network; and

a sending module, configured to: add the ETR information found by the searching module to the data packet, and send the data packet to an ITR.

An ITR provided in an embodiment of the present invention includes:

a receiving module, configured to: receive a data packet that carries ETR information from an endpoint, and resolve the data packet;

a retrieving module, configured to retrieve the ETR information from the data packet received by the receiving module; and

an encapsulating module, configured to encapsulate the data packet according to the ETR information retrieved by the retrieving module.

Compared with the prior art, the embodiments of the present invention bring these benefits: The mapping server is searched to obtain the ETR information used for forwarding the data packet sent by the endpoint in the transit network, and the ETR information is carried in the data packet and sent to the ITR. Therefore, it is the endpoint that searches for the ETR information, and the pressure of searching for mapping information on the ITR is relieved.

### BRIEF DESCRIPTION OF THE DRAWINGS

FIG. 1 shows an Internet architecture that separates the ID from the locator in the prior art;

FIG. 2 is a schematic diagram of sending traffic from endpoint A to endpoint B in an edge network in the prior art;

FIG. 3 is a flowchart of a method for sending mapping information in an embodiment of the present invention;

FIG. 4 shows how an endpoint searches for mapping information and sends a data packet in an embodiment of the present invention;

FIG. 5 shows a structure of a system for sending mapping information in an embodiment of the present invention;

FIG. 6 shows a structure of an endpoint in an embodiment of the present invention; and

FIG. 7 shows a structure of an ITR in an embodiment of the present invention.

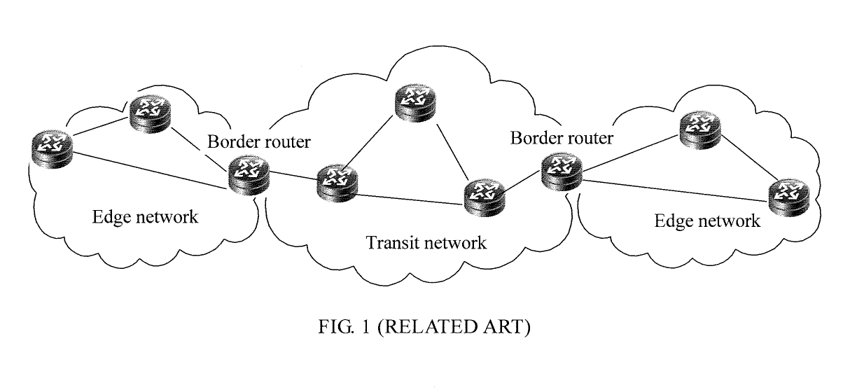

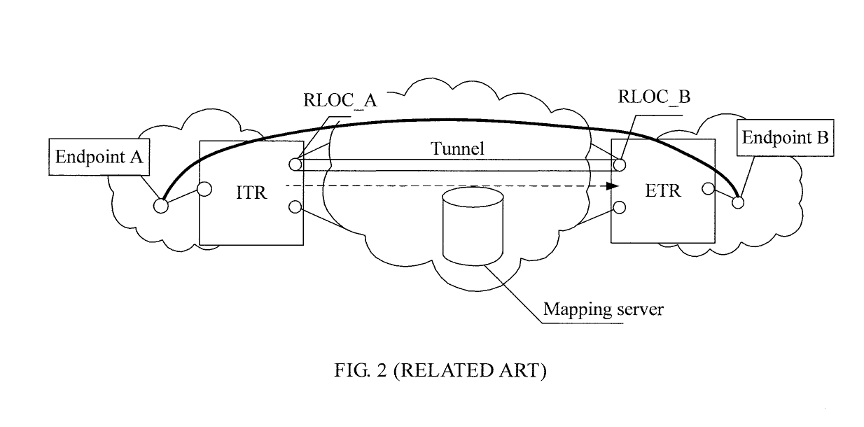

### DETAILED DESCRIPTION OF THE EMBODIMENTS

In a method for sending mapping information in an embodiment of the present invention, the BR information corresponding to the destination endpoint is found based on the endpoint, the found BR information is carried in the data packet, and the pressure of searching for mapping information on the ITR is relieved.

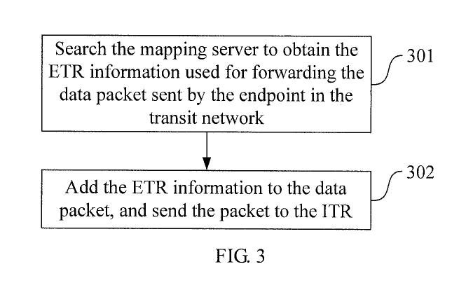

FIG. 3 is a flowchart of a method for sending mapping information in an embodiment of the present invention. The method includes the following steps:

301: Search the mapping server to obtain the ETR information used for forwarding the data packet sent by the endpoint in the transit network.

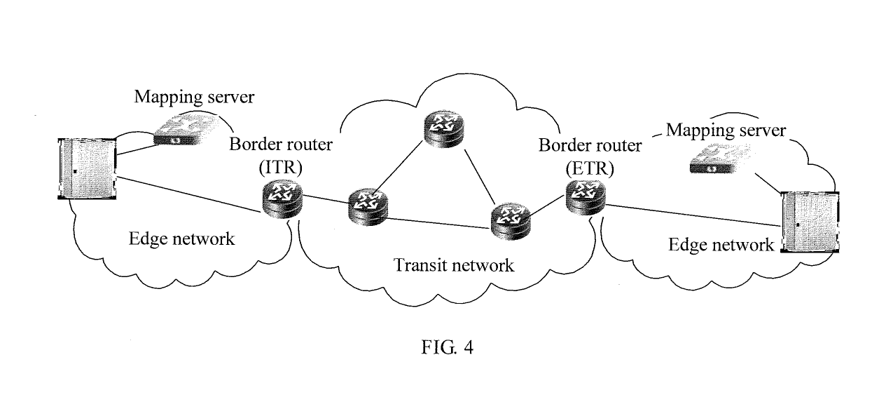

The data packet may be an IP packet or an Ethernet packet. In this embodiment, it is assumed that the data packet is an IP packet and that the endpoint is a host. As shown in FIG. 4, before the host initiates a communications connection to the destination host through a Transmission Control Protocol (TCP)/User Datagram Protocol (UDP), the host searches the mapping server to obtain the BR information corresponding to the destination host, namely, ETR information. In the case of LISP, the ETR information is RLOC information; in the case of HLP or ENCAPS, the ETR information is AS No. information.

302. Add the ETR information to the data packet, and send the packet to the ITR.

As shown in FIG. 4, after obtaining the ETR information, the host adds the ETR information to the IP packet, and sends the packet to the ITR. For example, the host adds the RLOC information or AS No. information to an IPv4 option, or adds the RLOC information or AS No. information as a new field in an IPv6 packet. The IP packet further carries the EID of the host that sends the IP packet and the EID of the destination host of the IP packet.

After receiving the IP packet, the ITR retrieves the ETR information corresponding to the destination host from the IP packet, namely, retrieves the RLOC information or AS No. information, and then encapsulates the IP packet. Specifically, the ITR adds a sync header to the received IP packet, and the sync header carries the RLOC or AS No. information of the ITR and the ETR. Afterward, the ITR forwards the encapsulated IP packet to the ETR, or to the BR of the destination AS. In the case of HLP, because the AS No. is not directly routable, the ITR needs to resolve the next-hop IP address corresponding to the AS-level route according to the AS No.

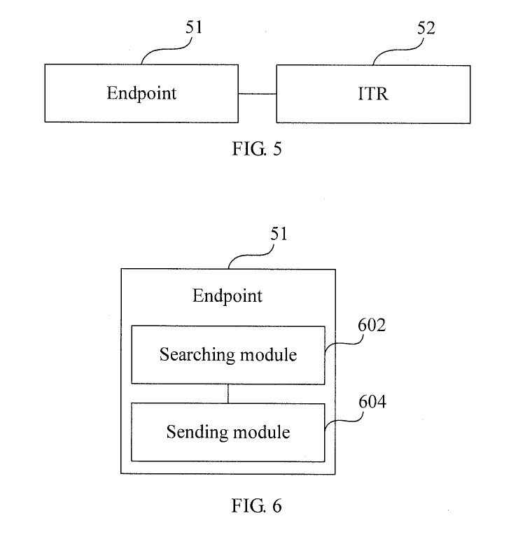

FIG. 5 shows a structure of a system for sending mapping information in an embodiment of the present invention. The system includes an endpoint 51 and an ITR 52. The endpoint 51 is configured to: search a mapping server to obtain ETR information used for forwarding a data packet sent by the endpoint 51 in a transit network, add the ETR information to the data packet, and send the data packet. The endpoint 51 may be a host or another terminal device.

The ITR 52 is configured to: receive the data packet that carries the ETR information from the endpoint 51, resolve the data packet, retrieve the ETR information from the data packet, and encapsulate the data packet according to the ETR information.

FIG. 6 shows a structure of an endpoint 51 in an embodiment of the present invention. The endpoint 51 includes:

a searching module 602, configured to search a mapping server to obtain ETR information used for forwarding a data packet sent by the endpoint in a transit network; and

a sending module 604, configured to: add the ETR information found by the searching module 602 to the data packet, and send the data packet to an ITR.

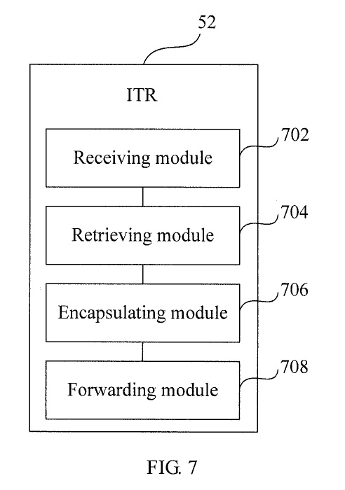

FIG. 7 shows a structure of an ITR 52 in an embodiment of the present invention. The ITR 52 includes:

a receiving module 702, configured to: receive the data packet that carries the ETR information from the endpoint, and resolve the data packet;

a retrieving module 704, configured to retrieve the ETR information from the data packet received by the receiving module 702;

an encapsulating module 706, configured to encapsulate the data packet according to the ETR information retrieved by the retrieving module 704; and

a forwarding module 708, configured to forward the data packet encapsulated by the encapsulating module 706 to the ETR.

Through the method, system, and apparatus for sending mapping information in the embodiments of the present invention, the endpoint searches the mapping server to obtain the ETR information; and the ITR does not need to search for the RLOC information or AS No. information. Therefore, the pressure of searching for mapping information on the ITR is relieved, the problems such as forwarding performance deterioration and packet loss caused by ITR overload are avoided, and the risks of Distributed Denial of Service (DDOS) attacks are reduced.

After reading the foregoing embodiments, those skilled in the art are clearly aware that the embodiments of the present invention may be implemented through hardware, or, preferably in most circumstances, through software in addition to a necessary universal hardware platform. Therefore, the technical solution under the present invention or its novelty in contrast to the prior art may be embodied as a software product. The software product may be stored in a computer-readable storage medium and incorporates several instructions for instructing a computer device (for example, a personal computer, a server, or a network device) to execute the method specified in any embodiment of the present invention.

The above descriptions are merely some exemplary embodiments of the present invention, but not intended to limit the scope of the present invention. Any modifications or variations that can be derived by those skilled in the art shall fall within the scope of the present invention.

What is claimed is:

1. A method for sending mapping information, comprising:
by an endpoint, searching a mapping server to obtain Egress Tunnel Router (ETR) information used for forwarding a data packet sent by the endpoint in a transit network; and
adding the ETR information to the data packet and sending the data packet to an Ingress Tunnel Router (ITR).

2. The method for sending mapping information according to claim 1, further comprising:
by the ITR, receiving and resolving the data packet, and retrieving the ETR information from the data packet.

3. The method for sending mapping information according to claim 2, further comprising:
by the ITR, encapsulating the data packet according to the ETR information, and forwarding the encapsulated data packet to the ETR.

4. The method for sending mapping information according to claim 1, wherein the ETR information comprises:
Routing Locator (RLOC) information or Autonomous System Number (AS No.) information.

5. A system for sending mapping information, comprising:
an endpoint, configured to search a mapping server to obtain Egress Tunnel Router (ETR) information used for forwarding a data packet sent by the endpoint in a transit network, add the ETR information to the data packet, and send the data packet to an Ingress Tunnel Router (ITR); and
the ITR, configured to receive the data packet that carries the ETR information from the endpoint, resolve the data packet, retrieve the ETR information from the data packet, and encapsulate the data packet according to the ETR information.

6. An endpoint, comprising:
a searching module, configured to search a mapping server to obtain Egress Tunnel Router (ETR) information used for forwarding a data packet sent by the endpoint in a transit network; and
a sending module, configured to add the ETR information found by the searching module to the data packet, and send the data packet to an Ingress Tunnel Router (ITR).

7. An Ingress Tunnel Router (ITR), comprising:
a receiving module, configured to receive a data packet that carries Egress Tunnel Router (ETR) information from an endpoint, and resolve the data packet;
a retrieving module, configured to retrieve the ETR information from the data packet received by the receiving module; and
an encapsulating module, configured to encapsulate the data packet according to the ETR information retrieved by the retrieving module.

8. The ITR according to claim 7, further comprising:
a forwarding module, configured to forward the data packet encapsulated by the encapsulating module to an ETR.

9. The method for sending mapping information according to claim 2, wherein the ETR information comprises:
Routing Locator (RLOC) information or Autonomous System Number (AS No.) information.

10. The method for sending mapping information according to claim 3, wherein the ETR information comprises:
Routing Locator (RLOC) information or Autonomous System Number (AS No.) information.
